(19) United States
(12) Patent Application Publication
(10) Pub. No.: US 2024/0084530 A1
(43) Pub. Date: Mar. 14, 2024

(54) ROADWAY WORK AREA SAFETY TRUCK

(71) Applicant: Royal Truck & Equipment, Inc., Coopersburg, PA (US)

(72) Inventors: Robert H. Roy, Emmaus, PA (US); Andrew C. Washburn, Shoemakersville, PA (US); Joseph T. Piggott, Easton, PA (US); Siddharth Balasubramanian, Allentown, PA (US)

(73) Assignee: Royal Truck & Equipment, Inc., Coopersburg, PA (US)

(21) Appl. No.: 18/517,814

(22) Filed: Nov. 22, 2023

Related U.S. Application Data
(63) Continuation of application No. 17/883,097, filed on Aug. 8, 2022, now abandoned.
Application No. 17/883,097 is a continuation of application No. 16/896,776, filed on Jun. 9, 2020, now Pat. No. 11,408,138.
Application No. 16/896,776 is a continuation of application No. 16/159,813, filed on Oct. 15, 2018, now Pat. No. 10,801,169.
Application No. 16/159,813 is a continuation of application No. 16/132,376, filed on Sep. 15, 2018, now Pat. No. 10,556,545.
Application No. 16/132,376 is a continuation of application No. 15/913,562, filed on Mar. 6, 2018, now Pat. No. 10,319,227.
Application No. 15/913,562 is a continuation of application No. 15/197,685, filed on Jun. 29, 2016, now abandoned.
(60) Provisional application No. 62/638,818, filed on Mar. 5, 2018.
(60) Provisional application No. 62/631,840, filed on Feb. 18, 2018.
(60) Provisional application No. 62/186,036, filed on Jun. 29, 2015.

(51) Int. Cl. E01F 9/70; B60P 3/14; B60R 11/06; B60R 21/00; B60R 21/02; E01F 9/662; E01F 15/14

(52) U.S. Cl. CPC E01F 9/70; B60P 3/14; B60R 11/06; B60R 21/00; B60R 21/02; E01F 9/662; E01F 15/148

(57) ABSTRACT

Right and left safety module embodiments are designed to be installed in openings located midway along right and left sides of flatbed trucks. The modules include a standing platform and an intermediate platform. While the truck is being driven alongside a roadway work zone, a worker standing on the module's standing platform either 1) moves traffic delineators one at a time from the intermediate platform, and then places the delineators at spaced locations alongside the roadway work zone, or 2) removes traffic delineators one at a time from spaced locations alongside the roadway work zone, and then places the delineators onto the intermediate platform. Vertically movable safety rails and pivotal safety gates of the modules prevent falls from the modules of workers standing on the standing platform.

### CROSS-REFERENCE TO RELATED APPLICATIONS

This application is a continuation of U.S. patent application Ser. No. 17/883,097 filed on Aug. 8, 2022, which is a continuation of U.S. patent application Ser. No. 16/896,776 filed Jun. 9, 2020, now U.S. Pat. No. 11,408,138, which is a continuation of U.S. patent application Ser. No. 16/159,813, filed Oct. 15, 2018, now U.S. Pat. No. 10,801,169, which is a continuation-in-part of U.S. patent application Ser. No. 16/132,376, filed Sep. 15, 2018, now U.S. Pat. No. 10,556,545, which is a continuation-in-part of U.S. patent application Ser. No. 15/913,562, filed Mar. 6, 2018, now U.S. Pat. No. 10,319,227, which is a continuation-in-part of U.S. patent application Ser. No. 15/197,685, filed Jun. 29, 2016, now abandoned. U.S. patent application Ser. No. 15/913,562 claims the benefit of U.S. Provisional Patent Application No. 62/631,840, filed Feb. 18, 2018, and U.S. Provisional Patent Application No. 62/638,818, filed Mar. 5, 2018. U.S. patent application Ser. No. 15/197,685 claims the benefit of the filing date of U.S. Provisional Patent Application No. 62/186,036, filed Jun. 29, 2015. The disclosures of all the above-cited applications are hereby incorporated herein by reference in their entireties as if fully set forth.

### BACKGROUND

So-called “traffic delineators” (also known as “traffic delineation safety markers”) are well known that are positioned alongside highway work zones to define lines of demarcation that separate the work zones from highway lanes where traffic is maintained while construction and repair work is underway inside the work zones.

Most traffic delineators in present-day use are formed from relatively lightweight plastic materials that have hollow, upstanding configurations that narrow as they extend upwardly, thereby permitting identically configured delineators to be nested one atop another to form nested stacks.

One common configuration of present-day traffic delineator takes the form of such hollow barrel-like members as are disclosed in the seventeen patents that follow namely U.S. Pat. Nos. 8,794,172, 6,786,673, 6,478,505, 6,019,542, 5,868,520, 5,234,280, 5,201,599, 4,973,190, 4,710,053, 4,674,431, 4,083,033, 3,952,690, D486,089, D481,965, D243,075, D243,073 and D229,784, the disclosures of which are incorporated herein by reference.

The barrel-like traffic delineators disclosed in the seventeen patents listed just above have closed, relatively small diameter upper end regions, with stepped diameter sidewalls that depend to relatively large diameter, open bottom end regions that permit identical ones of the barrel-like delineators to be stacked one atop another to form nested stacks that often are transported atop the flatbeds of commercially available flatbed trucks.

Another common configuration of present-day traffic delineator takes the form of such hollow, generally conical, stepped diameter structures as are disclosed in U.S. Pat. Nos. 6,182,600, D406,543 and D338,631, the disclosures of which are incorporated herein by reference. Nested stacks of identical ones of these hollow, conical delineators (such the nested stack shown in FIG. 3 of U.S. Pat. No. 6,182,600) are also commonly transported atop the flatbeds of trucks of various types.

Still another common configuration of traffic delineator takes the form of such tapered, upwardly pointing conical structures (commonly called “traffic cones”), such as is disclosed in U.S. Pat. Nos. 4,925,334, 4,219,141 and 3,788,268, the disclosures of which are incorporated herein by reference. These traffic cone delineators also can be transported in nested stacks, such as are shown in FIG. 4 of U.S. Pat. No. 4,925,334.

Although the tasks of placing even large, heavy and awkward-to-grasp-lift-and-move barrel-like traffic delineators alongside highway work zones, and of retrieving such traffic delineators from alongside highway work zones tend to be relatively dangerous undertakings, these tasks can be rendered less dangerous:
1) If the worker who is performing these tasks is adequately guarded, restrained, and/or otherwise prevented from accidentally falling from a vehicle that is moving the worker alongside a highway work zone where traffic delineators are being placed, or from which traffic delineators are being retrieved;
2) If a convenient-to-reach, near-knee-height, vehicle surface is provided beside the worker where traffic delineators are located that are to be grasped by the worker and then placed along-side the highway work zone, and onto which retrieved traffic delineators are to be placed; and
3) If such body movements as are required of the worker while performing the tasks explained just above are minimized, so the worker performing these tasks is not required to significantly turn, twist and otherwise exert his or her body while lifting, moving and placing even large, heavy and awkward-to-grasp-and-move barrel-like traffic delineators as the vehicle on which the worker is standing moves alongside a highway work zone.

A proposal that was offered prior to the year 2000 that was intended to address at least some of the dangerous concerns that are associated with the placement of traffic delineators alongside, and the retrieval of traffic delineators from alongside highway work zones, is presented in U.S. Pat. No. 6,183,042 issued Feb. 6, 2001 to Albert Unrath, the disclosure of which patent is incorporated herein by reference.

The Unrath proposal (as depicted in drawings of the Unrath patent) provides a stand-on platform located at the base of a relatively tall compartment wherein a work-person is intended to stand, with a waist-high safety chain being draped across the front of the compartment to retain the worker in the compartment especially when, for example, he or she leans forward to perform the tasks of putting down, and picking up, traffic delineators to and from spaced locations alongside a highway work zone.

Although the Unrath patent attempts to address at least some aspects of the safety concerns associated with the placement and retrieval of traffic delineators to and from spaced locations alongside a highway work zone, the Unrath proposal tends to raise more safety concerns than it cures.

One significant safety concern presented by the Unrath proposal is that the only vehicle surface (as shown in the drawings of the Unrath patent) that can be utilized to support traffic delineators during the placement of, and the retrieval of traffic delineators alongside a highway work zone, is an above-waist-high vehicle surface that has only a small surface area located beside, and a larger surface area extending behind, where a worker stands while in the tall compartment provided by Unrath.

What Unrath's awkwardly-placed, above-waist-high vehicle surface (for supporting traffic delineators) requires is that:
1) If a worker standing in the tall compartment of Unrath is to repetitively place large, relatively heavy and awkward to handle barrel-like traffic delineators one after another at locations spaced alongside a highway work zone, he or she must first turn his or her body more than ninety degrees before reaching up to grasp, and then to lift, each barrel-like delineator, one-at-a-time from where it resides on the above-waist-high vehicle surface—whereafter he or she must then reverse-turn his or her body to move each newly grasped and raised delineator more than ninety degrees before then leaning over the waist-high safety chain to lower the relatively large, heavy and awkward-to-handle barrel-like traffic delineator onto a newly chosen spaced location alongside a highway work zone—while, at the same time, the vehicle on which the worker is being carried, moves alongside the highway work zone; and
2) If a worker standing in the tall compartment of Unrath is to repetitively retrieve the large, relatively heavy and awkward-to-handle barrel-like traffic delineators from spaced locations alongside a highway work zone, he or she must first lean over the waist-high safety chain of Unrath to grasp and lift each delineator up and over the waist-high safety chain, and then the worker must turn his or her body more than ninety degrees while leaning back to turn and move each delineator that has been lifted over the safety chain to an even higher height to overlie the above-waist-high vehicle surface—whereafter the worker must then lower each of the raised delineators, one at a time, onto the above-waist-high vehicle surface—before then turning back to face a next-to-be-retrieved traffic delineator that is located alongside the work zone being followed by the vehicle that carries the worker.

All of this repetitive lifting, lowering, leaning and turning of the worker's body unquestionably severely stresses the back and body of a worker who has been assigned to perform these various movements time after time. When a worker has had to perform these duties to place and/or to retrieve hundreds of traffic delineators one-at-a time during a typical workday, the worker's back and body has almost always become painful, and his or her muscles often have been strained.

Such activities performed repetitively from a relatively tall compartment in a moving vehicle can also render a worker likely to become dizzy and/or to fall from the compartment that is guarded only by a waist-high safety chain draped across the front of the compartment.

### SUMMARY OF THE INVENTION

The present invention relates to modular units that have left-side and right-side embodiments (which are mirror images of each other) that can be incorporated into opposite left-side and right-side regions of the flatbeds of such trucks as are commonly used to transport and store barrel-like traffic delineators that are to being placed at spaced locations alongside highway work zones, and that are being retrieved from spaced locations alongside highway work zones.

Because barrel-like traffic delineators are widely used in many regions of the United States, and because barrel-like traffic delineators are the type of traffic delineators that are almost always more sizable and more awkward to handle than are traffic delineators of other types and configurations, the modular units of the present invention are especially designed to safeguard workers who are tasked to place and/or to retrieve even the large, relatively heavy, and often awkward-to-handle barrel-like traffic delineators that are in wide use throughout the United States.

Because many types of flat-bed trucks are in use to move workers alongside highway work zones to place and retrieve traffic delineators, such modular units as embody the preferred practice of the present invention are configured to be easily incorporated into right and left sides of a wide variety of the flatbeds of such trucks.

### BRIEF DESCRIPTION OF THE DRAWINGS

The present invention will hereinafter be described in conjunction with the appended drawing figures wherein like numerals denote like elements.

FIG. 1 is a perspective view showing the left side (i.e., the driver's side) of a conventional, commercially available, flatbed truck that is provided with an over-cab rack (such as is disclosed in the previously referenced provisional application) for transporting a plurality of horizontally extending nested stacks of barrel-like traffic delineation safety markers, with the view also showing 1) a commercially available crash attenuator device extending rearwardly from the truck, 2) an electronic warning sign board carried at the rear of the flatbed of the truck that is shown in a raised position, and 3) a left-side module embodying one form of the present invention;

FIG. 2 is a perspective view of the right side of the truck of FIG. 1, with the electronic sign board lowered to an out-of-view position, with the view showing a right-side module that is a mirror-image reversal of the left-side module depicted in FIG. 1;

FIG. 3 is a perspective view, on an enlarged scale, of a more preferred form of the right-side module, with the view showing all but two of the module's movable components in their closed and/or lowered positions;

FIG. 4 is a front elevational view of the right-side module;

FIG. 5 is a front elevational view showing the right-side module with many of the module's front components removed so that other components of the module can be seen;

FIG. 6 is a right end elevational view of the right-side module;

FIG. 7 is a perspective view, on the same enlarged scale as FIG. 3, of a left-side module that is a mirror-image-reversal of the right-side module;

FIG. 8 is a front elevational view of the left-side module;

FIG. 9 is another front elevational view of the left-side module, but with many of the front components of the module removed so that other components of the module can be seen;

FIG. 10 is a right end elevational view of the left-side module;

FIG. 11 is yet another perspective view of the right-side module, but with certain of the movable components of the right-side module moved to open positions;

FIG. 12 is a front elevational view of the right-side module, with broken lines depicting alternate positions of some of the movable components of the module;

FIG. 13 is a top plan view of the right-side module with some components removed, and with broken lines depicting alternate positions of other components; and

FIG. 14 is a right-end elevational view similar to FIG. 6, with selected components pivoted to open positions.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

To aid in describing the invention, directional terms are used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

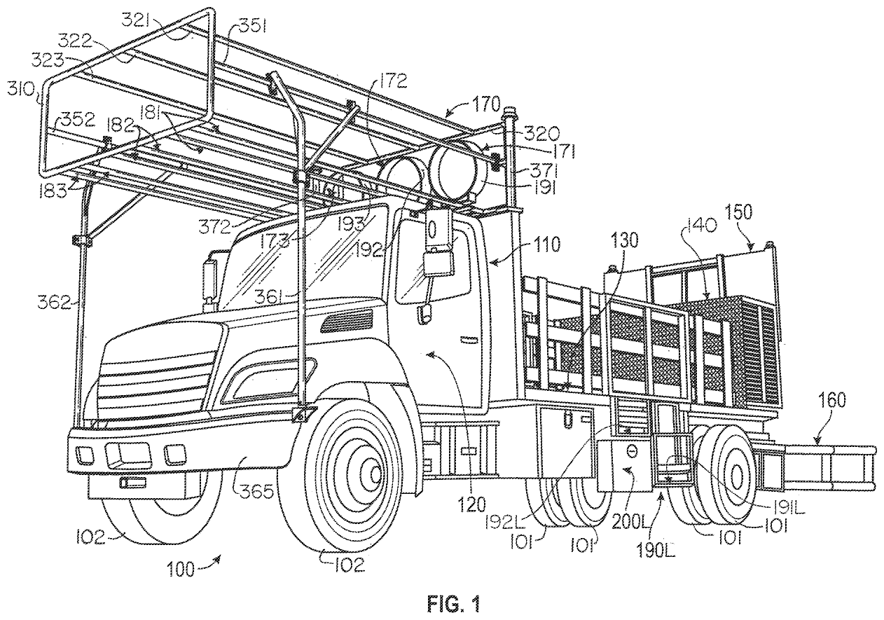

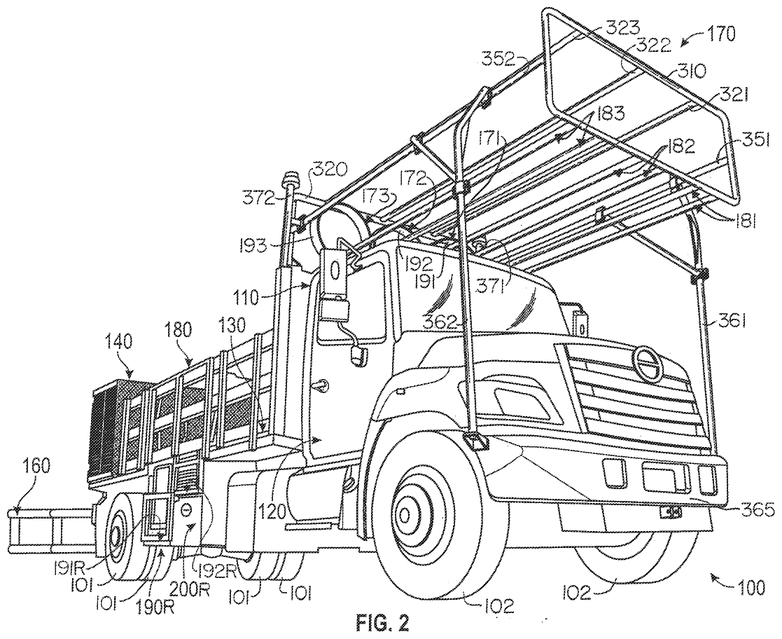

Referring to the left-side view provided by FIG. 1, and the right-side view provided by FIG. 2, a conventional, commercially available flatbed truck is indicated generally by the reference numeral 100. The truck 100 has tandem rear wheels that carry rear tires 101, and steerable front wheels that carry front tires 102. The truck 100 also has a conventional cab 110, which has the usual right-side and left-side cab access doors, that are indicated by the numeral 120 in each of FIGS. 1 and 2. While the principles of the invention have been described above in connection with preferred embodiments, it is to be clearly understood that this description is made only by way of example and not as a limitation of the scope of the invention.

Overview of the Truck 100:

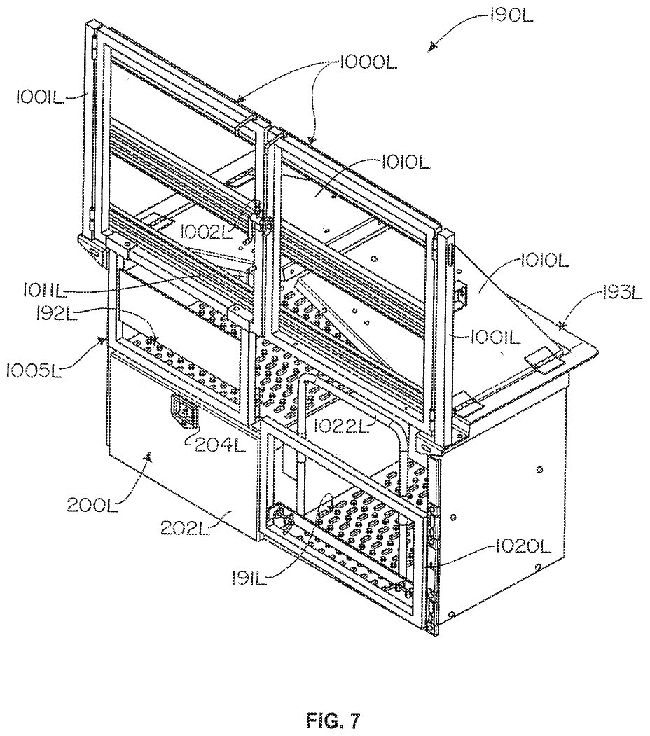

In overview, and continuing to refer to FIGS. 1 and 2, the truck 100 can be seen to also have a conventional flatbed 130 for hauling various forms of cargo (not shown) that often includes a supply of such barrel-like traffic delineators as are disclosed in FIG. 7 of the referenced provisional application.

An optional storage compartment 140 is provided at the rear of the flatbed 130. FIG. 1 also shows an optional, rearwardly facing, electronic sign board 150 located at the rear of the flatbed 130 of the truck 100. In FIG. 1 the sign board 150 is shown in an elevated position that permits what is displayed on the rearwardly-facing sign board to be viewed by motorists who approach the truck 100 from behind the truck 100. In FIG. 2, the electronic sign board 150 is not seen because the sign board has been lowered to an out-of-view storage position that is hidden, at least in part, by the optional storage compartment 140.

Referring still to FIGS. 1 and 2, an optional, commercially available crash attenuator unit 160 is shown connected to, and extending rearwardly from, the rear of the truck 100. When the sign board 150 shown in FIG. 1 is lowered to an out-of-view storage position (where the electronic sign board 150 cannot be seen, as in FIG. 2), the electronic sign board 150 is then moved out of the path of travel that is followed by components of the crash attenuator unit 160 when components of the crash attenuator unit 160 fold upwardly and forwardly to a transport position (not shown by the drawings of the present document) where components of the crash attenuator unit 160 overlie not only the optional storage compartment 140 but also a rear part of the flatbed 130 of the truck 100.

One embodiment of the crash attenuator unit 160 is depicted in much greater detail in FIG. 1 of U.S. Pat. No. 9,399,8454. How components of the crash attenuator 160 can fold both upwardly and forwardly to the transport position mentioned just above is shown in FIGS. 1A-1B of U.S. Pat. No. 8,322,945. The disclosures of both of these patents are incorporated by reference.

Returning, once again, to FIGS. 1 and 2, it can be seen that an optional rack structure 170 overlies the cab 110 of the truck 100. This rack structure 170 is the subject of the previously referenced provisional application that was filed by the inventors named in the present application.

At substantially identical left-side and right-side locations just forward of the rear tires 101 of the truck 100, are left-side and right-side modules 190L and 190R, respectively, that are the subject of the present application. As will be explained, the modules 190L and 190R are provided to assist workers to safely place, and to safely retrieve, traffic delineators to and from spaced locations alongside highway work zones as the truck 100 moves alongside the work zones while carrying a worker in one of the compartments defined by one of the modules 190L/190R, as will be explained.

The left-side and right-side modules 190L/190R shown in FIGS. 1 and 2 are principally depicted to illustrate typical locations on opposite sides of a conventional flatbed truck 100 where such modules as embody the present invention can be positioned, and put to use. Accordingly, any differences in appearance between the modules 190L/190R shown in FIGS. 1 and 2 and the preferred forms of the modules 190L/190R shown in the remainder of the drawing views of the application are to be ignored.

Overview of the Over-Cab Rack Structure 170:

As shown in each of FIGS. 1 and 2 of the present application:

The rack structure 170 includes three identical rack assemblies 171, 172, 173 that extend in parallel, side-by-side, relationship, with each of the rack assemblies including a pair of straight, parallel-extending, rails that are indicated by the numerals 181, 182, 183, respectively.

Each of the pairs of rails 181, 182, 183 slidably supports one of three identically configured hoop assemblies 191, 192, 193, respectively, that can be slid freely back and forth along an associated pair of the elongate rails 181, 182, 183, respectively.

Each of the barrel racks 171, 172, 173 is configured to receive a separate nested stack of barrel-like traffic delineators, with a narrow end region of an uppermost one of the barrel-like traffic delineators of each nested stack being inserted into an associated one of the hoop assemblies 191, 192, 193, and with the largest end regions of each of the barrel-like traffic delineators of the associated nested stack of delineators being supported by an associated pair of the elongate rails 181, 182, 183—as is explained in connection with FIG. 7 of the referenced provisional application.

By this arrangement, a large number of barrel-like traffic delineators can be compactly stored and transported in the form of three nested stacks of the barrel-like traffic delineators that extend side-by-side, with each of the nested stacks being supported by one of the hoop assemblies 191, 192, 193, and by an associated pair of the elongate rails 181, 182, 183, respectively, of the rack structure 170—which leaves much, if not most, of the flatbed 130 of the truck 100 open and available for use by workers who move about on the surface of the flatbed 130 of the truck 100 as they feed traffic delineators into, and remove traffic delineators from, the over-cab rack structure 170.

As can be seen in one or the other of FIG. 1 or 2, the rack structure 170 is rendered structurally sound by virtue of the pairs of rails 181, 182, 183 having their opposite end regions welded to identically configured front and rear rectangular structures 310, 320, respectively, that are provided at opposite front and rear end regions of the rack structure 170. Moreover, the rack structure 170 is strengthened by elongate members 191, 192, 193 that overlie the barrel racks 171, 172, 173, respectively. The elongate members 191, 192, 193 help to retain nested stacks of delineators in place in each of the barrel racks 171, 172, 173, respectively—it being noted that the elongate members 191, 192, 193 have their opposite front and rear end regions welded to the front and rear rectangular structures 310, 320, respectively.

To support the rack structure 170 atop the cab 110 of the truck 100, the rack structure 170 is also provided with a pair of forwardly-rearwardly extending tubular members 351, 352 that extend between the front and rear rectangular structures 310, 320 at locations above the left and right sides, respectively, of the cab 110 of the truck 100. Also, left and right upwardly extending supports 361, 362 are provided that connect with a front bumper 365 of the truck 100, and with the left and right tubular members 351, 352, respectively. Additionally, left and right upwardly extending supports 371, 372 are provided that connect with rear regions of the left and right tubular members 351, 352, respectively. By this arrangement, the rack structure 170 is securely supported as it overlies the cab 110 of the truck 100.

Overview of the Modules 190L/190R:

To simply the description that follows, when corresponding left-side and right-side components XXXL and XXXR are being referred to, a simplified statement such as “the components XXXL/XXXR” is often be used. This eliminates the need to use a longer, more formal statement such as “the left-side and right-side components XXXL and XXXR, respectively, that correspond to each other.”

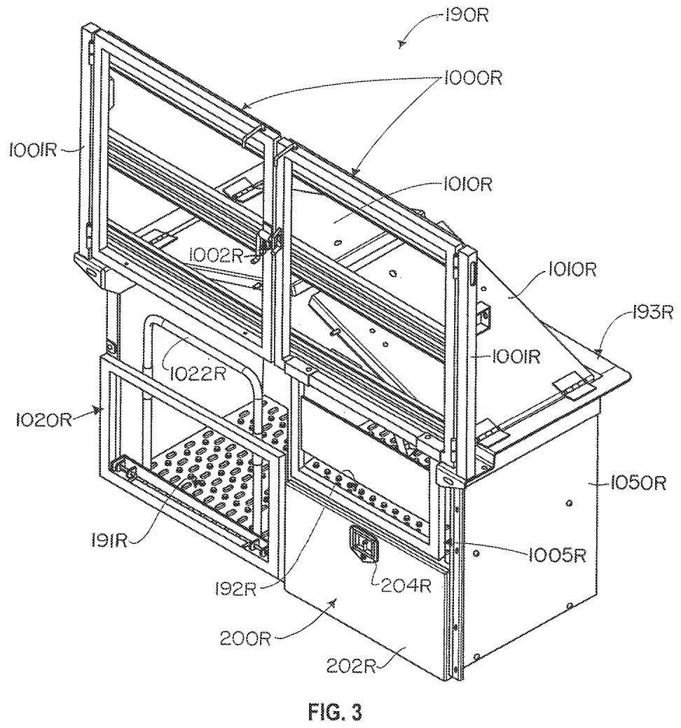

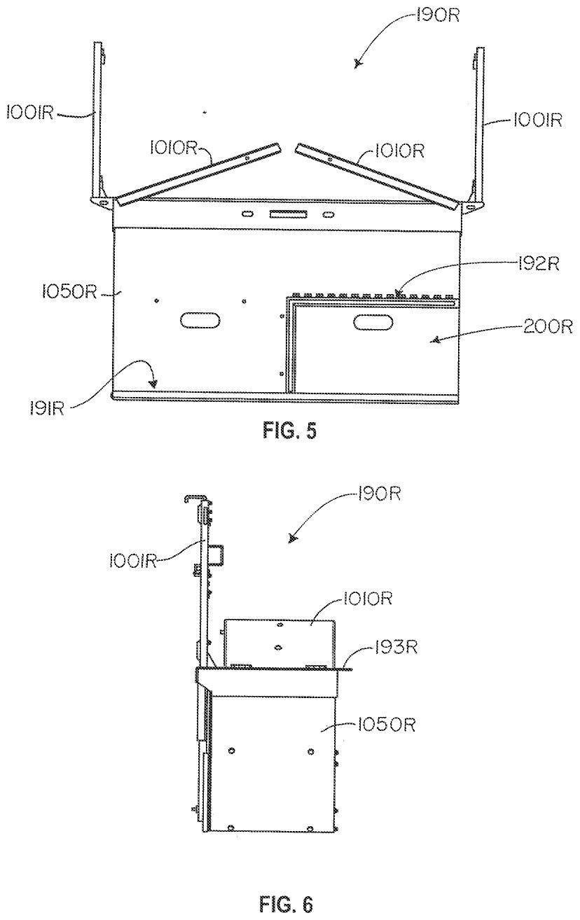

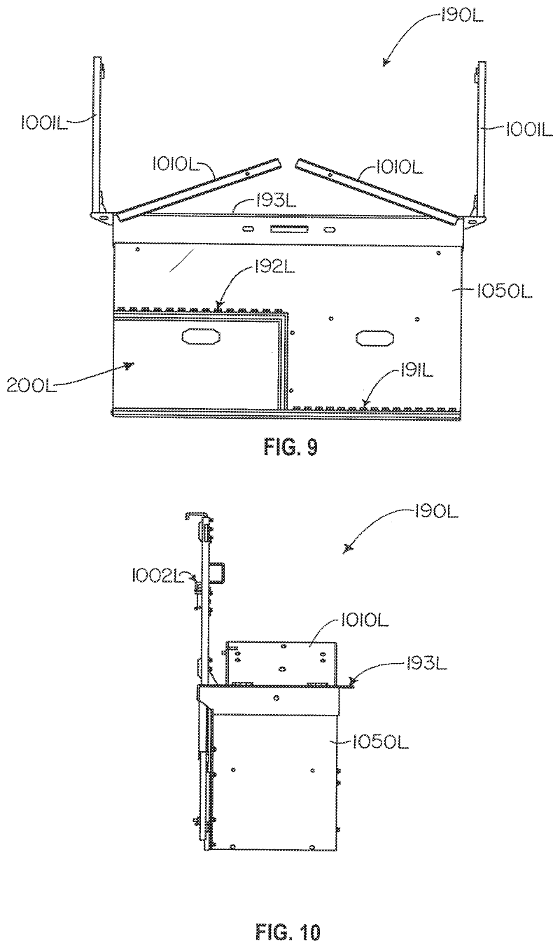

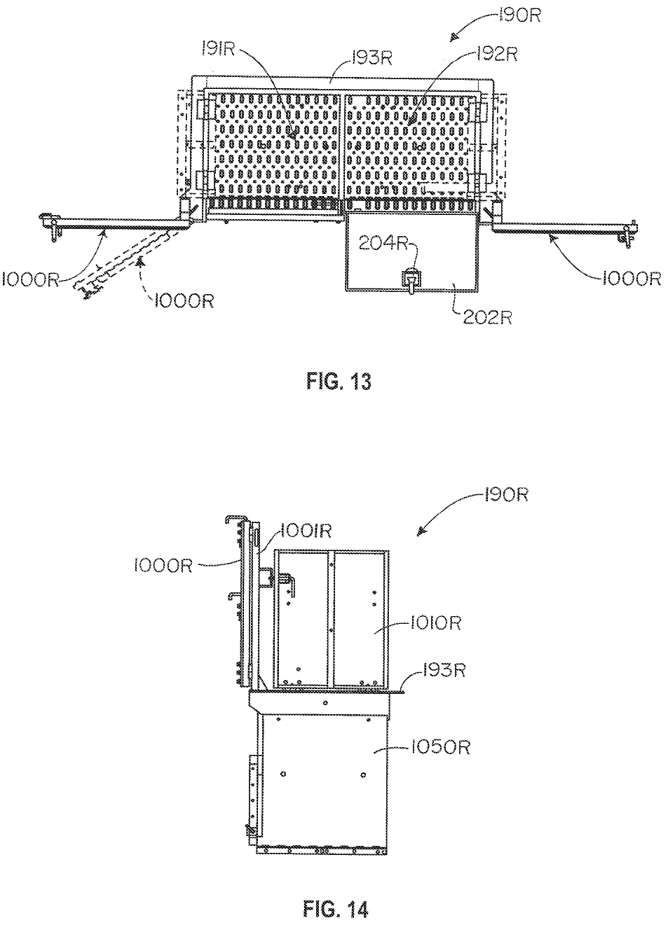

Although this section of the present application is principally intended to refer to the left-side module 190L as depicted in FIG. 1, and to the right-side module 190R as depicted in FIG. 2, what is said in this section of the application is applicable to the preferred forms of the left-side module 190L and the right-side module 190R that are shown in various ones of FIGS. 3-14.

As can be seen in the left-side view provided by FIG. 1, and the right-side view provided by FIG. 2, each of the modules 190L/190R has both a lower platform (that is indicated generally by an associated one of the numerals 191L/191R), and an upper platform (that is indicated generally by an associated one of the numerals 192L/192R).
1) It is important, for reasons of safety, that the modules 190L/190R AND their lower platforms 191L/191R AND their upper platforms 192L/192 have at least certain minimum dimensions that permit the modules and their lower and upper platforms to safely serve their intended purposes. In preferred practice, the modules 190L/190R and their lower and upper platforms 191L/191R and 192L/192R, respectively, are at least dimensionally sized in the following ways:
2) Each of the modules 190L/190R preferably have widths of no less than about 60 inches, as measured from left to right, and preferably have depths of at least 24 inches deep, as measured from front to rear.
3) Each of the lower platforms 191L/191R is preferably no less than about 30 inches wide, as measured from left to right, and is preferably no less than about 24 inches deep, as measured from front to rear.
4) Each of the upper platforms 192L/192R is preferably no less than about 30 inches wide, as measured from left to right, and is preferably no less than about 24 inches deep, as measured from front to rear.

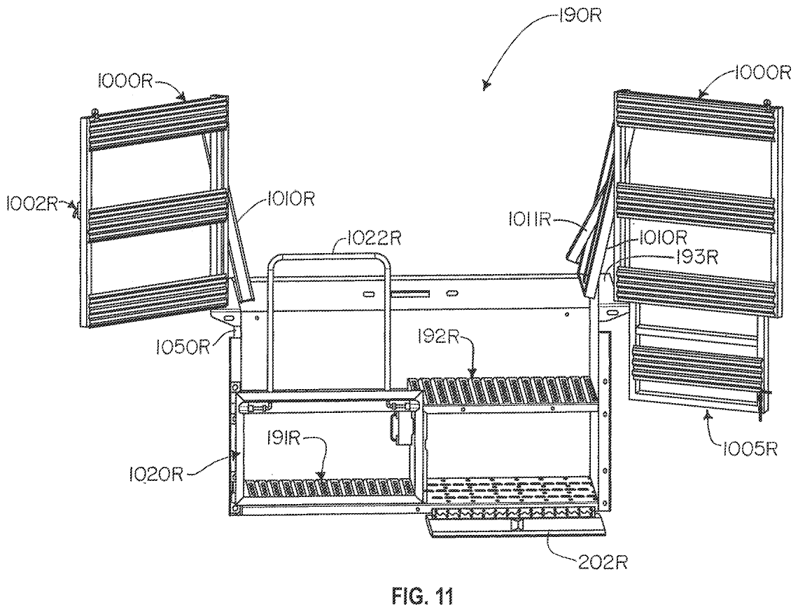

Each of the upper platforms 192L/192R is preferably located at a height that is approximately eighteen inches above the height of the associated one of the two lower platforms 191L/191R—which is a height that selected to be substantially equal to, or slightly lower than, the knee heights of average workers who will stand on one of the lower platforms 191L/191R while in one of the compartments 195L/195R provided by an associated one of the modules 190L/190R. These upper level platform heights have been found to render it relatively easy for a worker standing in one of the compartments 195L/195R to grasp and move even large, heavy-and-awkward-to-grasp-and-move barrel-like traffic delineators one at a time from one of the upper platforms 192L/192R onto a highway surface;
A. for a worker standing in one of the compartments 195L/195R to grasp and place one of the large, heavy-and-awkward-to-grasp-and-to-place barrel-like traffic delineators that have been retrieved one at a time from a highway surface onto one of the upper level platforms 192L/192R; and
B. for a worker who occasionally needs to transition up or down between one of the lower level platforms 191R/191L and a nearby portion of the flatbed 130 of the truck 100, to use one of upper level platforms 192L/192R as a step surface while moving between one of the lower level surfaces 191L/191R and the flatbed surface 130 of the truck 100.
5) As can also be seen in FIGS. 1 and 2, the upper level platforms 192L/192R are located atop tool boxes 200L/200R that also form components of each of the modules 190L/190R. The tool boxes 200L/200R have pivotally mounted front doors 202L/202R that are each provided with a suitably configured latch assembly 204L/204R. When one of the latch assemblies 204L/204R is operated to unlatch an associated one of the front doors 202L/202R, the unlatched front door is permitted to pivot downwardly to an open position such as is depicted in FIG. 11.

Housings that form the opposed, upstanding side walls, and the rear walls of each of the modules 190L/190R are best shown in various ones of FIGS. 3, 5-6 and FIGS. 7, 9-10, where these housings are indicated generally by the numerals 1050L/1050R.

How the Modules 190L/190R are Ordinarily Put to Use:

During normal placement and retrieval of traffic delineators to and from highway surfaces alongside which trucks 100 such as are shown in FIGS. 1 and 2 are being driven so that workers carried on the flatbed 130 and on one of the lower level platforms 191L/191R of an associated one of the modules 190L/190R can work in harmony to take advantage of the facts that:
1) The upper level platforms 192L/192R provide sizeable support surfaces where barrel-like traffic delineators can be temporarily placed, one at a time, while these typically cumbersome, relatively large, heavy and awkward-to-grasp-and-move delineators are in the process of being moved up or down, to and from the flatbed 130 of the truck 100 (while the truck 100 that is carrying at least one worker on the truck's flatbed 130, and one worker on standing one of the lower level platforms 191L/191R) moves alongside a highway work zone where barrel-like traffic delineators are either to be put down at spaced locations alongside the highway work zone, or are to be picked up from spaced locations alongside the highway work zone.
2) When the delineators are to be placed on a highway road surface at spaced locations alongside a highway work zone, the delineators are first moved, one at a time, (by a worker who is standing on the flatbed 130 of the truck 100) from the flatbed 130 of the truck 100 to one of the upper level platforms 192L/192R of one of the modules 190L/190R, and then the delineators are moved, one at a time, by a worker who is standing on an associated one of the lower level platforms 191L/191R onto the highway road surface along-side which the truck 100 is moving.
3) When delineators are to be retrieved and collected from spaced locations alongside a highway work zone, a worker standing on one of the lower level platforms 191L/191R lifts each of the delineators, one at a time, from the highway surface, and places the retrieved delineators, one at a time, onto an associated one of the upper level platforms 192L/192R, whereafter another worker who is standing on the flatbed 190 of the truck 100 lifts each of the delineators, one at a time, from the upper level platform 192L/192R and places the delineator on the flatbed of the truck 100, whereafter the barrel-like delineators may be inserted into the over-cab rack 170.

Among the significant advantages that are provided by the modules 190L/190R is that relatively little repetitive lifting, lowering, twisting and turning needs to be performed by the bodies of either of the workers who are standing on the flatbed 130 of the truck 100, or on a lower level platform 191L/191R of one of the modules 190L/190R while performing such activities as are explained just above. The presence and the use that is made of the sizable upper level platforms 192L/192R minimizes the amount of lifting and lowering of traffic delineators that each of these workers must perform and the location of the sizeable upper level platforms 192L/192R at a near knee height minimizes the amount of lifting, twisting and turning that a worker who is standing on one of the lower level platforms 191L/191R must perform while placing retrieved traffic delineators onto, and while taking traffic delineators from one of the two upper level platforms 192L/192R for placement alongside a highway work zone.

Turning to the Modules 190L/190R as Shown in FIGS. 3-14:

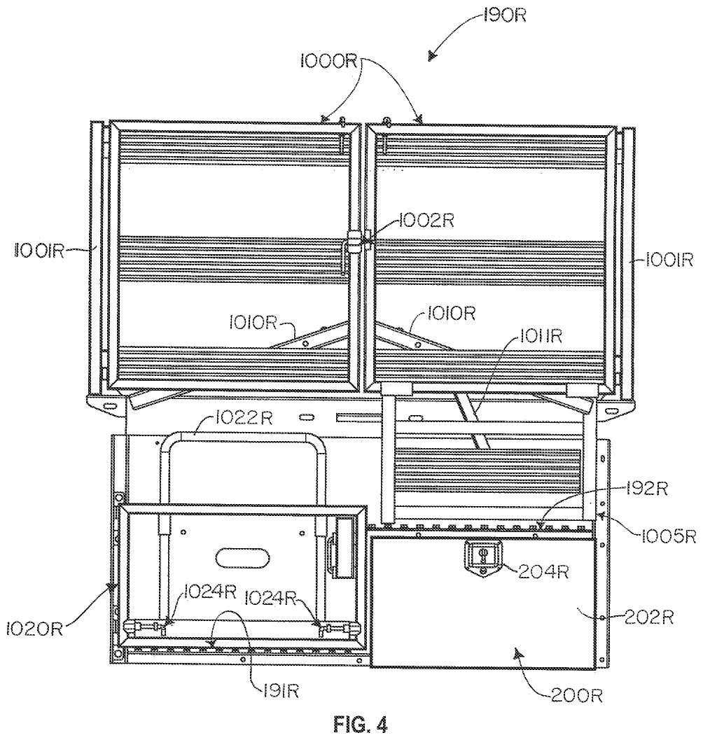

Before turning to the preferred forms of the modules 190L/190R that are shown in various ones of FIGS. 3-14), it should first be noted that:
1) FIGS. 3-5 and FIGS. 11-14 show components and features of a preferred form of the right-side module 190R, wherein—
   FIGS. 3 and 4 show many of the movable components of the right-side module 190R in their “closed” and/or “lowered” positions, whereas
   FIG. 11 shows most of the movable components of the module 190R in their “open” and/or “raised” positions, and
2) FIGS. 6-10 show components and features of a preferred form of the left-side module 190L—it being understood that the movable components of the left-side module 190L have appearances that are mirror image reversals of corresponding ones of the movable components of the right-side module 190R, as depicted in FIGS. 3-5 and 11-14.

Movable Components of the Modules 190L/190R:

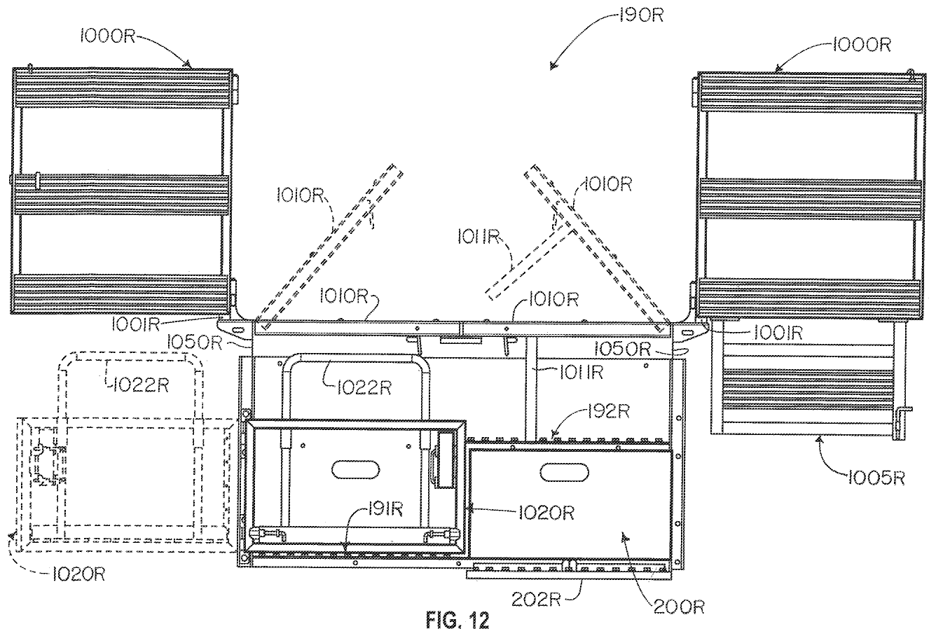

Each of the right-side and left-side modules 190R/190L is provided with a corresponding set of pivotally and slidably movable components that provide access to various regions of the modules 190L/190R, as will now be explained:
1) Pivotally mounted gates 1000L/1000R that preferably each have a fence-like appearance are provided atop each of the right-side and left-side modules 190L/190R. These fence-like, pivotally mounted gates 1000L/1000R are pivotally connected to upstanding components 1001L/1001R (best shown in FIGS. 3-4 and 7-8) and can pivot from closed positions best shown in FIGS. 3-4 and 7-8, to open positions (such as is shown in FIG. 12) where the gates 1000L/1000R prefer-ably extend closely alongside other fence-like guards that (as can be seen in FIGS. 1 and 2) extend along opposite right and left sides of the flatbed 130 at locations just forwardly of, and just rearwardly of, the modules 190L/190R.

Fully open positions of the right-side fence-like gates 1000R are shown in FIG. 12. Fully open positions of the left-side fence-like gates 1000L will be understood to have appearances that are mirror images of the right-side fence-like gates 1000R shown in FIG. 12.

Partially open positions of the right-side fence-like gates 1000R are shown in FIG. 11. Corresponding partially open positions of the left-side fence-like gates 1000L will be understood to have appearances that are mirror images of the right-side fence-like gates 1000R shown in FIG. 11.

Latch assemblies that are indicated generally by the numerals 1002L/1002R in FIGS. 3-4 and 7-8 are provided to releasably retain the right-side and left-side fence-like gates 1000L/1000R in their closed positions.
2) Depending extensions 1005L/1005R are provided on only one of each of the left-side and right-side fence-like gates 1000R/1000L.

A right-side fence-like gate 1000R that is provided with a depending extension 1005R is best shown in FIGS. 11 and 12. When closed, the right-side depending extension 1005R restricts access to, and visually blocks a view of, a region of the right-side module 190R that overlies the upper platform 192R of the right-side module 190R.

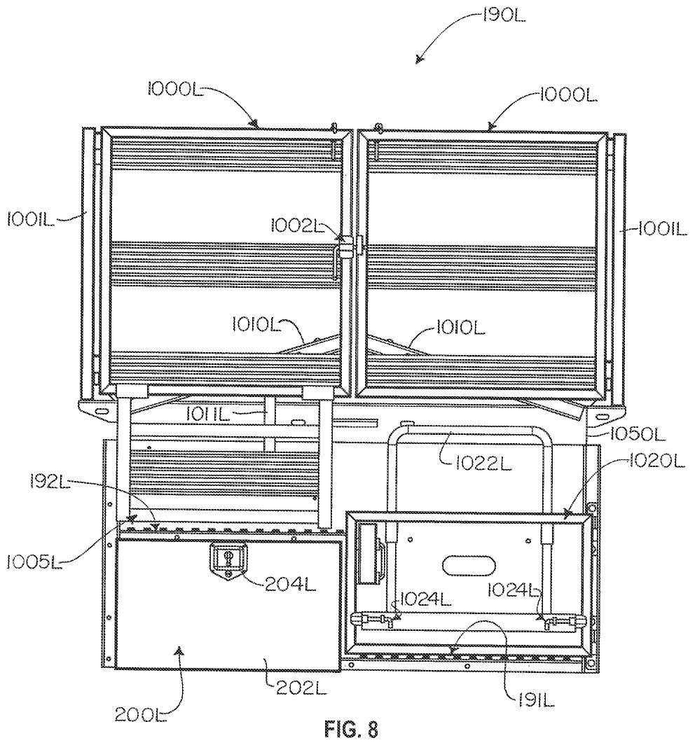

A left-side fence-like gate 1000L that is provided with a depending extension 1005L (that corresponds to the right side depending extension 1005R) is best shown in FIG. 8. As can be seen in FIG. 8, when closed, the depending extension 1005L restricts access to, and visually blocks a view of, a region of the left-side module 190L that overlies the upper platform 192L of the left-side module 190L.

In the left-side view of FIG. 7, and in the right-side view of FIG. 3, depending extensions 1005L/1005R are shown that differ slightly in appearance from the appearances of the depending extensions 1005L/1005R shown in FIGS. 11-12 and 8, respectively. However, the depending extensions 1005L/1005R that are shown in FIGS. 3 and 7 perform in substantially the same manner as the depending extensions 1005L/1005R that are shown in FIGS. 11-12 and 8, respectively, to restrict access to, and to visually block views of, regions located just above the upper platforms that are designated by the numerals 192L/192R, when the fence-like gates 1000L/1000R that carry the left-side and right-side depending extensions 1005L/1005R are moved to closed positions by the gates 1000L/1000R that carry these left-side and right-side depending extensions.
3) Referring to FIGS. 3 and 4, it can be seen that, located just behind the fence-like gates 1000R of the right-side module 190R are a pair of upwardly opening platform-like doors 1010R that can pivot from closed positions (wherein the platform-like doors 1010R provide upper surfaces that are substantially level with the upper surface of the flatbed 130 of the truck), to open positions wherein the platform-like doors 1010R extend substantially vertically and are latchingly retained by adjacent ones of the upstanding members 1010R (an example of which is shown in FIG. 14).

Corresponding platform-like doors 1010L of the left-side module 190L are shown in FIGS. 7 and 8. The left-side platform-like doors 1010R behave in the same way as the right-side platform-like doors 1010R, and have appearances that are mirror-image reversals of the right-side platform-like doors 1010R.

Closed positions of the platform-like doors 1010R are shown by solid lines in FIG. 12, while partially open positions of the platform-like doors 1010R are shown by solid lines in FIGS. 3, 4 and 11, and are indicated by broken lines in FIG. 12.

Flat surface plates 193R/193L are shown in FIGS. 3 and 7 to which the platform-like doors 1010R and 1010L are pivotally connected, respectively.

Each of the platform-like doors 1010R/1010L that overlies one of the upper level platforms 192L/192R pivotally carries a depending support 1011R/1011L that extends substantially vertically when the associated platform-like door 1010R/1010L is closed to thereby support the associated platform-like doors 1010R/1010L in their fully closed positions.
4) Structurally strong guard assemblies 1020L/1020R extend in front of the compartments 195L/195R of the modules 190L/190R to securely retain workers within the compartments 195L/195R while performing such tasks as are explained above to place and retrieve barrel-like delineators to and from spaced locations alongside a highway work zone.

The tubular guard assemblies 1020L/1020R can be unlatched and pivoted from the closed positions that are shown in FIGS. 3-4 and 7-8 (and by solid lines in FIG. 12), to an unlatched and fully open positions (an example of which is shown by broken lines in FIG. 12). Also, a tubular component 1022L/1022R of each of the guard assemblies 1020L/1020R can be unlatched and slid upwardly to any of a progression of latchingly-retained heights, with a full-height position of one of the tubular components 1022L/1022R being shown in FIG. 11.

Latch assemblies that are provided to releasably retain the tubular guard assemblies 1022L/1022R in their raised and lowered positions are best shown in FIGS. 4 and 8, where these latch assemblies are indicated by the numerals 1024L/1024R, respectively.

The various movable components of the modules 190L/190R that are enumerated above provide access to various regions of the modules 190L/190R to permit work-persons to enter and leave various regions of the modules 190L/190R as may be needed, and to provide the latchable tubular guard components 1022L/1022R at heights that are appropriate for workers of different heights to be properly retained within the compartments 195L/195R of the modules 190L/190R.

Although the invention has been described in a preferred form with particularity, it is understood that the present disclosure of the preferred form has been made only by way of example, and that numerous changes in the details of construction and the combination and arrangement of parts may be resorted to without departing from the spirit and scope of the invention.

What is claimed:

1. A module for attachment to a flat bed of a truck for assisting workpersons to place barrel-like traffic delineators onto, and to retrieve barrel-like traffic delineators from highway surfaces, comprising a housing that encloses and supports a lower level platform at the bottom of a compartment defined by the housing wherein a workperson can comfortably stand, and an upper level platform located beside the compartment on which barrel-like traffic delineators can be temporarily positioned that are delivered one at a time from the flat bed of the truck for being placed on a highway surface by a workperson standing in the compartment, and on which barrel-like traffic delineators can be placed, one at a time, after being retrieved from the highway surface by a workperson standing in the compartment.

2. The module of claim 1 that has left-side and right-side embodiments that provide appearances that are mirror-image reversals of each other.

3. The module of claim 2 wherein each of the left-side and right-side embodiments have fence-like gates that each extend along and above a different one of the lower level and upper level platforms.

4. The module of claim 2 wherein each of the left-side and right-side embodiments have a platform-like door that can overlie a different one of the lower level and upper level platforms.

5. The module of claim 1 additionally including a structurally strong guard assembly with an upwardly movable tubular component that can be positioned at a variety of releasably latchable heights at locations in front of a workperson standing in the compartment of the module.
